(19) United States
(12) Patent Application Publication
(10) Pub. No.: US 2025/0147338 A1
(43) Pub. Date: May 8, 2025

(54) EYEGLASSES WITH ELASTIC LIMITING STRUCTURE

(71) Applicant: Wenzhou Langyao Design Co., Ltd., Wenzhou (CN)

(72) Inventor: Enhong HE, Wenzhou (CN)

(21) Appl. No.: 19/014,446

(22) Filed: Jan. 9, 2025

(30) Foreign Application Priority Data
Sep. 23, 2024 (CN) 202411323729.2
Sep. 23, 2024 (CN) 202422313654.1

(51) Int. Cl. G02C 5/22

(52) U.S. Cl. CPC G02C 5/2218

(57) ABSTRACT

Eyeglasses includes an eyeglass frame, an eyeglass temple, and a connecting member. The eyeglass temple is mounted on the eyeglass frame. The eyeglass temple is rotatably connected to the eyeglass frame. The eyeglass temple is provided with a connecting member and is rotatably connected to the eyeglass frame by the connecting member. A slot is provided in a position of the eyeglass frame corresponding to the connecting member. A notch is provided in a first side of the slot for the connecting member to rotate in and out of the slot. The connecting member is configured to insert into the slot to form a rotatable connection with the eyeglass frame. The slot is provided with an elastic member. The connecting member is provided with a first groove and a second groove corresponding to positions where the eyeglass temple is opened or closed, respectively.

### CROSS-REFERENCE TO RELATED APPLICATIONS

This application claims the benefit of priority from Chinese Patent Application No. 202422313654.1 and No. 202411323729.2, filed on Sep. 23, 2024. The content of the aforementioned application, including any intervening amendments thereto, is incorporated herein by reference in its entirety.

### TECHNICAL FIELD

This application relates to eyeglasses, more particularly to eyeglasses with an elastic limiting structure.

### BACKGROUND

A connection way of an eyeglass temple and an eyeglass frame can be divided into elastic hinge connection and inelastic hinge connection according to whether the connection position of the eyeglass temple and the eyeglass frame has elasticity. The elastic hinge has a one-piece structure and a split structure.

Chinese utility model patent (CN217787528U) discloses a snap-in slingshot for eyeglass frame (one-piece structure), which requires purchasing a finished slingshot or assembling the slingshot by oneself, and then installs the assembled slingshot onto the eyeglass temples. However, the slingshot has a more complicated structure and high cost.

Chinese utility model patent (CN216118259U) discloses an eyeglass slingshot that can be installed by laser welding. The spring part is a split structure, and it is necessary to fill the spring into the groove of the eyeglass temple by oneself when installing the spring, install a part of the hinge to the eyeglass temple, and fix the hinge by means of screws. The spring part is more complicated in the installation, resulting in lower installation efficiency.

Therefore, the existing eyeglasses with elastic hinges still have the problems of low installation efficiency or high cost.

### SUMMARY

In view of the deficiencies in the prior art, this application provides eyeglasses with an elastic limiting structure, which has high installation efficiency, low cost and simple structure.

Technical solutions of this application are described as follows.

This application provides eyeglasses with an elastic limiting structure, comprising:
an eyeglass frame;
an eyeglass temple; and
a connecting member;
wherein the eyeglass temple is mounted on the eyeglass frame; the eyeglass temple is rotatably connected to the eyeglass frame; the eyeglass temple is provided with the connecting member and is rotatably connected to the eyeglass frame by the connecting member; a slot is provided in a position of the eyeglass frame corresponding to the connecting member; a notch is provided in a first side of the slot for the connecting member to rotate in and out of the slot; the connecting member is configured to insert into the slot to form a rotatable connection with the eyeglass frame; the slot is provided with an elastic member; the connecting member is provided with a first groove corresponding to a position where the eyeglass temple is opened and a second groove corresponding to a position where the eyeglass temple is closed; and
the elastic member is abutted against the connecting member; and when the eyeglass temple is opened and closed in place, the elastic member is inserted in the first groove or the second groove to limit a rotation of the eyeglass temple.

In an embodiment, a bottom of the slot is provided with a positioning slot for placing the elastic member; the elastic member is located in the positioning slot, and at least a part of the elastic member is configured to extend out of the positioning slot and abut against the connecting member, so as to cooperate with the first groove and second groove for limiting the eyeglass temple.

In an embodiment, an arcuate transition is formed between a slot wall on a second side of the slot corresponding to the notch and the positioning slot.

In an embodiment, an arcuate transition is provided between a first position of the connecting member corresponding to the first groove and a second position of the connecting member corresponding to the second groove.

In an embodiment, the connecting member is integrally molded with the eyeglass temple.

In an embodiment, the first groove and the second groove are arcuate grooves.

In an embodiment, the elastic member is a hollow cylinder and has radial elasticity; and an outer peripheral surface of the elastic member is configured to fit the first groove and the second groove.

In an embodiment, the connecting member is longitudinally provided with a through hole; the through hole is configured for cooperating with a screw to rotatably connect with the eyeglass frame; and the connecting member is configured to rotate with the screw as a rotary axis.

Compared to the prior art, this application has the following beneficial effects.
1. The eyeglasses have the simple structure and does not require processing and installation of the eyeglass temples.
2. The eyeglasses can produce the elastic hand feedback when the eyeglass temple opens and closes in place.
3. The eyeglass temple will automatically pop open when the eyeglass temple is about to open and close in place.
4. The eyeglasses are easy to install and have low cost and high production efficiency.

### BRIEF DESCRIPTION OF THE DRAWINGS

FIG. 1 is an exploded view of eyeglasses according to an embodiment of the present disclosure;

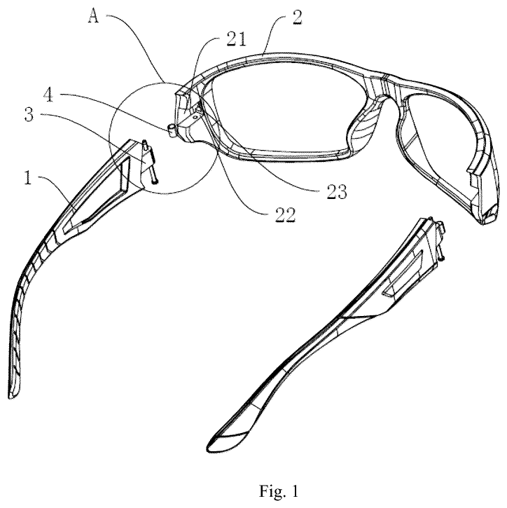

FIG. 2 is a sectional view of the eyeglasses according to an embodiment of the present disclosure;

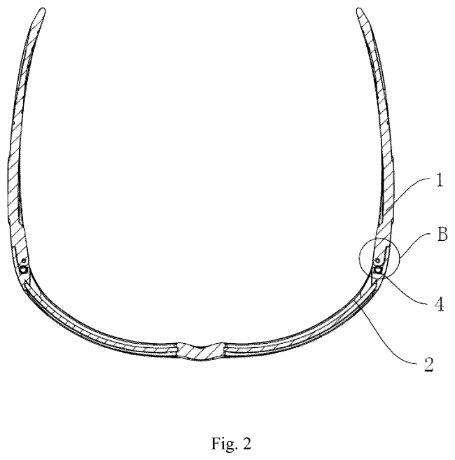

FIG. 3 is an enlarged view of part “A” in FIG. 1; and

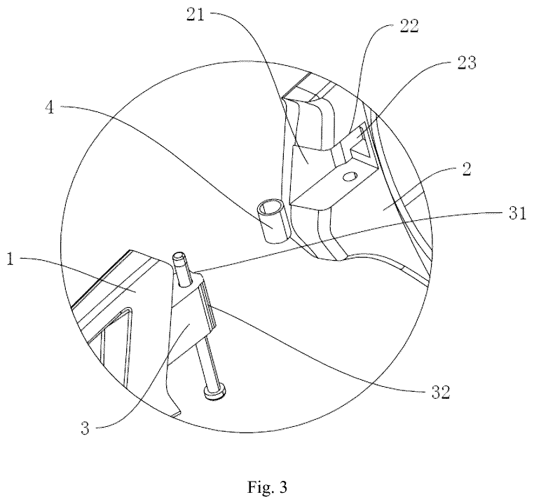

FIG. 4 is an enlarged view of part “B” in FIG. 2.

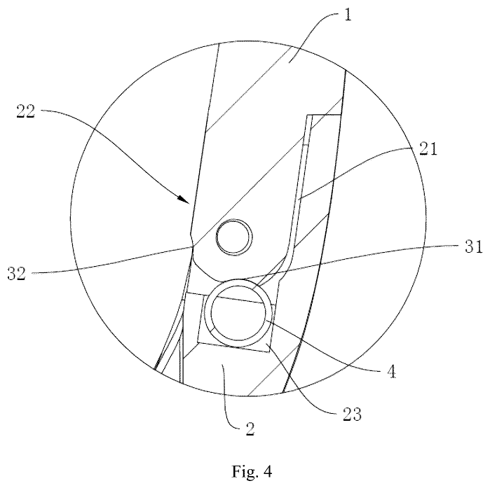

In the Figures: 1, eyeglass temple; 2, eyeglass frame; 21, slot; 22, notch; 23, positioning slot; 3, connecting member; 31, first groove; 32, second groove; 4, elastic member.

### DETAILED DESCRIPTION OF EMBODIMENTS

The disclosure will be further described in detail in conjunction with the accompanying drawings.

Eyeglasses with an elastic limiting structure provided herein include an eyeglass frame 2 and an eyeglass temple 1 mounted on the eyeglass frame 2. The eyeglass temple 1 is rotatably connected to the eyeglass frame 2. The eyeglass temple 1 is provided with a connecting member 3 and is rotatably connected to the eyeglass frame 2 by the connecting member 3. A slot 21 is provided on the position of the eyeglass frame 2 corresponding to the connecting member 3. A notch 22 is provided in the side of the slot 21 for the connecting member 3 to rotate in and out of the slot 21. The connecting member 3 is inserted in the slot 21 to form a rotatable connection with the eyeglass frame 2. The slot 21 is provided with an elastic member 4. The connecting member 3 is provided with a first groove 31 and a second groove 32 respectively at the positions corresponding to the open and close of the eyeglass temple 1. The elastic member 4 abuts the connecting member 3 so that the elastic member 4 is embedded into the first groove 31 or the second groove 32 to restrict the rotation of the eyeglass temple 1 when the eyeglass temple 1 is opened and closed in place.

In this embodiment, the eyeglass frame 2 and the eyeglass temple 1 are mounted by the connecting member 3 in conjunction with the slot 21. The connecting member 3 of the eyeglass temple 1 is inserted in the slot 21 and rotationally connected in the slot 21. The notch 22 corresponds to the rotation position of the eyeglass temple 1 where the eyeglass temple 1 is opened and closed, thereby allowing the connecting member 3 to enter and exit from the slot 21 when the connecting member 3 is rotated. The elastic member 4 in the slot 21 can be embedded in the slot 21 and allow the connecting member 3 to insert into the slot 21. The connecting member 3 is provided with the first groove 31 and the second groove 32 corresponding to the two states where the eyeglass temple 1 is opened in place and is closed in place, respectively. When the first groove 31 or the second groove 32 corresponds to the position of the elastic member 4, the elastic member 4 is embedded in the first groove 31 or the second groove 32, and the elastic member 4 cooperates with the first groove 31 or second groove 32 to limit the opening and closing of the eyeglass temple 1. The eyeglass temple 1 releases from the current state only when the force applied to the eyeglass temple 1 is sufficient for the elastic member 4 to deform and detach from the first groove 31 or the second groove 32. The elastic limiting part can replace the traditional slingshot structure, simplify the installation cost, and improve the installation efficiency. However, the elastic limiting part cannot replace the slingshot structure that opens immediately when released, i.e., the slingshot structure in which the eyeglass temple 1 in the closed state automatically opens outwardly under the action of the elastic force without being restricted by the external force.

When the above scheme is in use, the elastic member 4 in the initial state is embedded in the second groove 32 corresponding to the eyeglass temple 1 being closed in place, and restricts the opening of the eyeglass temple 1 through the cooperation of the elastic force and the second groove 32. When sufficient force is applied to open the eyeglass temple 1, the connecting member 3 will rotate along with the eyeglass temple 1 and force the elastic member 4 to produce the deformation. At this time, the elastic member 4 is disengaged from the second groove 32, which will reduce resistance drop. Until the eyeglass temple 1 is about to open in place, the edge of the connecting member 3 facing the first groove 31 corresponding to the eyeglass temple 1 opening in place starts to contact the elastic member 4. At the same time, the elastic member 4 starts to release and pop open under the action of elastic force, and cooperates with the first groove 31 to produce the pop-open action, providing the pop-open hand feeling feedback. Similarly, when the eyeglass temple 1 is closed in place, the pop-open hand feeling feedback is also generated.

The connecting member 3 is longitudinally provided with a through hole. The through hole is used to cooperate with a screw to rotatably connect with the eyeglass frame 2. The connecting member 3 rotates with the screw as a rotary axis. In this arrangement, the eyeglass temple 1 completes the assembly by installing the connecting member 3 with the eyeglass frame 2 through the screw. Moreover, the eyeglass temple 1 has a rotating effect. Therefore, the first groove 31 and the second groove 32 in the connecting member 3 can form a stable fit with the elastic member 4, and the elastic member 4 is kept in the eyeglass frame 2 and not loosened from the eyeglass frame 2.

The notch 22 can provide the elastic member 4 with a certain limiting effect, so that the elastic member 4 can be installed more conveniently. The size of the notch 22 can be smaller than that of the elastic member 4, such that the elastic member 4 is not easy to loosen from the notch 22 during installation. Of course, the size of the notch 22 can be larger than that of the elastic member 4. For example, the entire groove wall on one side of the slot 21 is open.

In an embodiment, in order to facilitate installation, the bottom of the slot 21 is provided with a positioning slot 23 for placing the elastic member 4. The elastic member 4 is located in the positioning slot 23, and at least a part of the elastic member 4 extends out of the positioning slot 23 and abuts against the connecting member 3, so as to cooperate with the first groove 31 and the second groove 32 in the connecting member 3 to limit the eyeglass temple 1. During installation, it is only necessary to fill the elastic member 4 into the positioning slot 23 to allow the elastic member 4 to be in a more stable state. Then, the first groove 31 of the connecting member 3, which corresponds to a position where the eyeglass temple is opened, presses against the elastic member 4, so that the elastic member 4 can be in a stable state, and will not be ejected and lost under the action of the elastic force, so that the installation can be more convenient. Then, the through hole in the connecting member 3 is aligned with the through hole on the eyeglass frame 2, the eyeglass temple 1, the elastic member 4, and the eyeglass frame 2 can be assembled by the screw. The size of the positioning slot 23 may preferably be the size adapted to the elastic member 4 to further stabilize its state.

In addition, an arcuate transition is formed between the slot wall on the other side of the slot 21 corresponding to the notch 22 and the positioning slot 23. By means of the arcuate transition, the installation can be more convenient, and the elastic member 4 can be slid into the positioning slot 23 by means of the slot wall of the slot 21 in conjunction with the arcuate transition. In fact, the arcuate transition can also cooperate with the connecting member 3 so that the rotation of the connecting member 3 will not be blocked.

In order to make the cooperation with the elastic member 4 smoother during the rotation of the connecting member 3, an arcuate transition is provided between the positions of the connecting member 3 corresponding to the first groove 31 and the second groove 32.

After the elastic member 4 leaves the first groove 31 or the second groove 32, the elastic member 4 will fit on the surface of the connecting member 3 for relative sliding, and the curved transition can make the sliding process smoother and will not produce an additional section hand feeling.

Since the above-described solution is not to assemble the elastic limiting structure within the eyeglass temple 1, and in order to make the cost lower and improve the production efficiency, preferably, the connecting member 3 is molded integrally with the eyeglass temple 1.

In addition, as a further improvement, the first groove 31 and the second groove 32 are curved grooves. The cooperation between the curved structure and the elastic member 4 can produce a more continuous effect, and at the same time can maintain a better hand feeling during the process of opening and closing the eyeglass temple 1.

Further, in an embodiment, the elastic member 4 is a hollow cylinder with radial elasticity. The outer peripheral surface of the elastic member 4 cooperates with the first groove 31 and the second groove 32. The surface of the cylindrical structure can form a more continuous transition with the curved first groove 31 and the curved second groove 32, without jamming. Moreover, the cylindrical structure can cooperate with the curved surfaces of the first groove 31 and the second groove 32, which produces a guiding effect, so that the eyeglass temple has a smoother and more stable pop-open effect when eyeglass temple is about to be opened or closed in place, thereby obtaining more stable and obvious elastic feel.

Described above are merely preferred embodiments of the disclosure, which are not intended to limit the disclosure. It should be understood that any modifications and replacements made by those skilled in the art without departing from the spirit of the disclosure should fall within the scope of the disclosure defined by the present claims.

What is claimed is:

1. Eyeglasses with an elastic limiting structure, comprising:
an eyeglass frame;
an eyeglass temple; and
a connecting member;
wherein the eyeglass temple is mounted on the eyeglass frame; the eyeglass temple is rotatably connected to the eyeglass frame; the eyeglass temple is provided with the connecting member and is rotatably connected to the eyeglass frame by the connecting member; a slot is provided in a position of the eyeglass frame corresponding to the connecting member; a notch is provided in a first side of the slot for the connecting member to rotate in and out of the slot; the connecting member is configured to insert into the slot to form a rotatable connection with the eyeglass frame; the slot is provided with an elastic member; the connecting member is provided with a first groove corresponding to a position where the eyeglass temple is opened and a second groove corresponding to a position where the eyeglass temple is closed;
the elastic member is abutted against the connecting member; and when the eyeglass temple is opened and closed in place, the elastic member is inserted in the first groove or the second groove to limit a rotation of the eyeglass temple; and
the elastic member is a hollow cylinder and has radial elasticity; and an outer peripheral surface of the elastic member is configured to fit the first groove and the second groove.

2. The eyeglasses of claim 1, wherein a bottom of the slot is provided with a positioning slot for placing the elastic member; the elastic member is located in the positioning slot, and at least a part of the elastic member is configured to extend out of the positioning slot and abut against the connecting member, so as to cooperate with the first groove and second groove for limiting the eyeglass temple.

3. The eyeglasses of claim 2, wherein an arcuate transition is formed between a slot wall on a second side of the slot corresponding to the notch and the positioning slot.

4. The eyeglasses of claim 1, wherein an arcuate transition is provided between a first position of the connecting member corresponding to the first groove and a second position of the connecting member corresponding to the second groove.

5. The eyeglasses of claim 1, wherein the connecting member is integrally molded with the eyeglass temple.

6. The eyeglasses of claim 1, wherein the first groove and the second groove are arcuate grooves.

7. The eyeglasses of claim 1, wherein the connecting member is longitudinally provided with a through hole; the through hole is configured for cooperating with a screw to rotatably connect with the eyeglass frame; and the connecting member is configured to rotate with the screw as a rotary axis.
